(19) United States
(12) Patent Application Publication
(10) Pub. No.: US 2024/0191368 A1
(43) Pub. Date: Jun. 13, 2024

(54) ELECTROCHEMICAL METHOD THAT FACILITATES THE RECOVERY OF CARBON DIOXIDE FROM ALKALINE WATER BY THE ACIDIFICATION OF SUCH WATER SOURCES ALONG WITH THE CONTINUOUS HYDROGEN GAS PRODUCTION

(71) Applicant: The Government of the United States of America, as represented by the Secretary of the Navy, Arlington, VA (US)

(72) Inventors: Felice DiMascio, Simsburg, CT (US); Heather D. Willauer, Fairfax Station, VA (US); Jeff Baldwin, Fairfax Station, VA (US); Dennis R. Hardy, California, MD (US)

(21) Appl. No.: 18/536,576

(22) Filed: Dec. 12, 2023

Related U.S. Application Data
(60) Provisional application No. 63/431,864, filed on Dec. 12, 2022.

(51) Int. Cl. C25B 9/23; C02F 1/461; C02F 1/66; C02F 101/10; C02F 103/08; C25B 9/70; C25B 11/036

(52) U.S. Cl. CPC C25B 9/23; C02F 1/46104; C02F 1/66; C25B 9/70; C25B 11/036; C02F 2001/46128; C02F 2101/10; C02F 2103/08; C02F 2201/008; C02F 2201/46115; C02F 2201/4613; C02F 2201/4617

(57) ABSTRACT

The present invention provides a device for carbon dioxide recovery from alkaline water using a module having at least three compartments where each compartment is separated by an electrode pair (anode and cathode) with electrochemical reactions occurring at the electrodes. The electrodes can be in a unipolar or bipolar configuration. Multiple electrochemical modules can be electrically connected in series, in parallel, or in a combination of both series and parallel. Also disclosed it the related process for recovering carbon dioxide from alkaline water.

### PRIORITY CLAIM

The present application is a non-provisional application claiming the benefit of U.S. Provisional Application No. 63/431,864, filed on Dec. 12, 2022 by Felice DiMascio et al., entitled “ELECTROCHEMICAL METHOD THAT FACILITATES THE RECOVERY OF CARBON DIOXIDE FROM ALKALINE WATER BY THE ACIDIFICATION OF SUCH WATER SOURCES ALONG WITH THE CONTINUOUS HYDROGEN GAS PRODUCTION.” This application and all other publications and patent documents referred to throughout this nonprovisional application are incorporated herein by reference in their entirety.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case No. 211208-US2.

### BACKGROUND OF THE INVENTION

### Field of the Invention

The invention relates to recovering carbon dioxide from alkaline water.

### Description of the Prior Art

The total carbon content of the world's oceans is roughly 38,000 GtC. Over 95% of this carbon is in the form of dissolved bicarbonate ion (HCO₃⁻). This ion along with carbonate is responsible for buffering and maintaining the ocean's pH which is relatively constant below the first 100 meters. This dissolved bicarbonate and carbonate of the ocean is essentially bound CO₂, and the sum of these species along with gaseous CO₂, shown in equation 1, represents the total carbon dioxide concentration [CO₂]_{T}, of seawater.

Σ[CO₂]_{T}=[CO₂(g)]₁+[HCO₃⁻]+[CO₃²⁻] (1)

At a typical ocean pH of 7.8, [CO₂]_{T} is about 2000 μmoles/kg near the surface, and 2400 μmoles/kg at all depths below 300 meters. This equates to approximately 100 mg/L of [CO₂]_{T} of which 2 to 3% is [CO₂ (g)] (equation 1), 1% is carbonate, and the remainder is dissolved bicarbonate. Johnson et al. showed that when the pH of seawater is decreased to 6 or less, the total CO₂ exists only in the dissolved gas form.

In addition to seawater, brine solutions, saturated alkaline carbonate solutions, brackish water, and freshwater contain dilute to concentrated CO₂ bound as bicarbonate and carbonate that the electrochemical configurations described within address as sources of CO₂. This CO₂ can be utilized for a vast array of applications ranging from liquid hydrocarbon fuel synthesis, synthesis of chemical intermediates (consisting of but not limited to CO, olefins, aromatics, methane, methanol, and formic acid), materials synthesis, and marine carbon dioxide removal solutions.

Previous work provides details of unipolar electrochemical conceptual module designs with the minimum number of three compartments and a prerequisite that the design can be expanded to have greater than three compartments. Each unipolar module configuration containing three compartments has a set of endblocks. These endblocks attribute substantial weight to the module unit.

### SUMMARY OF THE INVENTION

The purpose of the present invention is to electrically control the extraction of carbon dioxide from bicarbonate and carbonate containing alkaline water sources such as seawater, freshwater, brine, saturated alkaline carbonate solutions, and brackish water. The module apparatus incorporates configurations and materials of construction to reduce the size, weight, footprint, and cost of the module while maintaining electrical efficiencies to facilitate carbon removal from alkaline water sources. This is important for facilitating carbon dioxide gas removal and hydrogen gas and oxygen gas production from any alkaline water source, whether on land or at sea. For example, in a shipborne installation, an increase in the ship's weight is the biggest enemy of optimal design. It immediately leads to degradation in stability, speed, range, and structural integrity. Needless to say, any weight increase during the design or construction phases results in smaller margins for future growth, thereby limiting the ship's capabilities for decades to come. Moreover, this method only requires electricity and does not require acidic or caustic materials in the recovery of carbon from seawater.

These and other features and advantages of the invention, as well as the invention itself, will become better understood by reference to the following detailed description, appended claims, and accompanying drawings.

### BRIEF DESCRIPTION OF THE DRAWINGS

FIG. 1 shows electrode connections in a unipolar configuration with four electrode pairs.

FIG. 2 shows a configuration of a module for carbon dioxide removal with electrode connections in a unipolar configuration with three electrode pairs.

FIG. 3 shows a bipolar configuration with four electrode pairs.

FIG. 4 shows a configuration of a module for carbon dioxide removal with electrode connections in a bipolar configuration with three electrode pairs.

FIG. 5 shows four unipolar modules connected in series.

FIG. 6 shows four unipolar modules connected in parallel.

FIG. 7 shows four unipolar modules connected in series-parallel.

FIG. 8 shows four bipolar modules connected in series.

FIG. 9 shows four bipolar modules connected in parallel.

FIG. 10 shows four bipolar modules connected in series-parallel.

### DETAILED DESCRIPTION OF THE INVENTION

The present invention provides a device for carbon dioxide recovery from alkaline water using a module having at least three compartments where each compartment is separated by an electrode pair (anode and cathode), where each compartment comprises an anode section, an alkaline water section, and a cathode section with a cation-permeable membrane separating the anode section from the alkaline water section and another cation-permeable membrane separating the alkaline water section from the cathode section, where alkaline water is flowed through the alkaline water section of each compartment, where hydrogen ions and oxygen gas are generated at the anode, where hydroxide ions and hydrogen gas are generated at the cathode, where a current drives the hydrogen ions generated at the anode through the cation permeable membrane separating the anode section from the alkaline water section into the alkaline water section, where cations in the alkaline water are replaced by hydrogen ions which lowers the pH of the alkaline water, where the pH of alkaline solution is a function of the applied current, where the cations move through the cation permeable membrane separating the alkaline water section from the cathode section into the cathode section, where the cations combine with the hydroxide ions produced at the cathode, and where a DC power source is connected to at least one electrode pair. The module produces carbonic acid, bicarbonate ions, oxygen gas, hydroxides (not limited to sodium, potassium, magnesium, calcium), and hydrogen gas. The alkaline water section produces re-equilibrated carbon dioxide that is carbonic acid, which is removed as carbon dioxide gas. The device simultaneously produces hydrogen gas and carbon dioxide at a stoichiometric ratio ranging from 0.5:1 to 5:1. The molar ratio of hydrogen gas to carbon dioxide is controlled in part by varying the applied current density.

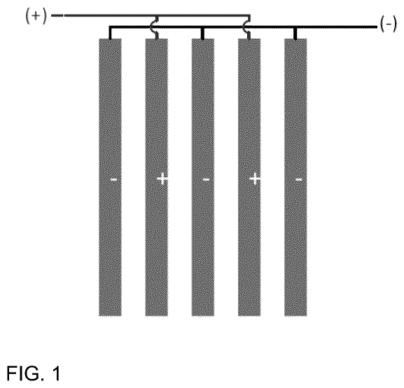

The new novel module configurations detail module designs have at least three compartments that result in a stack device. The stack device is advantageous as a reduction in endblock pairs will reduce the overall weight of the device. The electrode connections in the modules can be unipolar and bipolar. A simple arrangement of the electrode connections in a unipolar configuration is shown in FIG. 1. The current supplied by the power supply is capable of reversing the polarity of the anode and the cathode. In a preferred embodiment, the electrodes are identical to facilitate polarity reversal.

Unipolar configuration has anode and cathode pairs (with membranes and compartment in between) connected in parallel with one end of each anode being connected to a common point and each cathode connected to another common point to the power supply as shown in FIG. 1. The current supplied by the power supply is divided into four separate currents, each flowing through each electrode pair. The same electrochemical reaction (either the hydrogen evolution reaction (HER) or the oxygen evolution reaction (OER)) occurs on both sides of each electrode. After flowing through the electrode pair, the four currents rejoin into a current flowing back to the power supply. The total current flowing in the configuration is the sum of the separate currents flowing through the electrode pair:

I=I_{pair 1}+I_{pair 2}+I_{pair 3}+I_{pair 4}

The voltage drops across the electrode pairs are all equal:

V=V_{pair 1}=V_{pair 2}=V_{pair 3}=V_{pair 4}

The unipolar configuration is easy to fabricate and requires low maintenance, but presents high electrical currents at low voltages, causing large Ohmic losses in the electrical circuit connections (busbar are required vs cables).

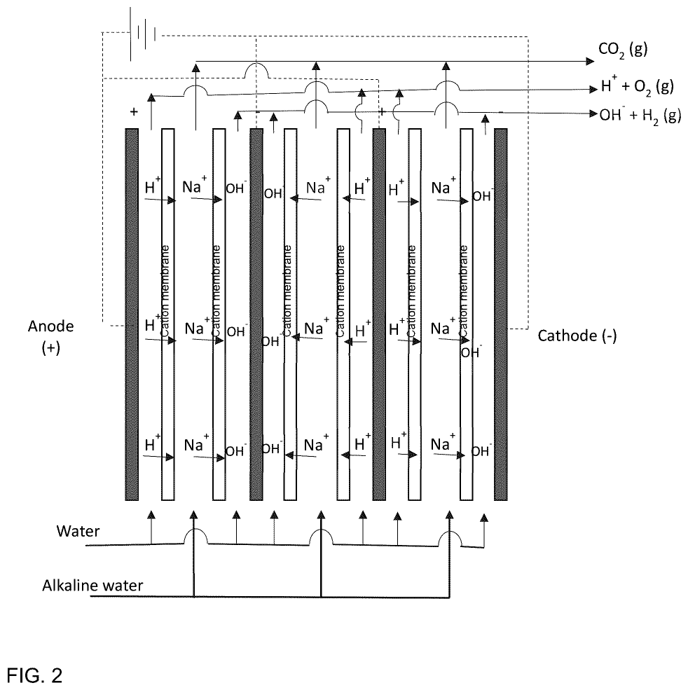

FIG. 2 shows the conceptual design configuration of the module for carbon dioxide removal with a unipolar configuration. The major components of the module include compartments separated by electrode compartments (anode and cathode), and cation-permeable membranes. Water is flowed through the anode and cathode compartments, while alkaline water is flowed through the central compartment of the module. The flow can be in either a bottom to top direction or in a top to bottom direction. A bottom to top direction is preferred for the electrode compartments. There are no starting electrolytes in any of the compartments. Hydrogen ions (H⁺) and oxygen gas (O₂) are generated at the electrodes. Current drives the H⁺ ions produced at the anode through the cation permeable membrane into the compartments containing alkaline water (seawater, freshwater, brine, saturated alkaline carbonate solutions, and brackish water). In the seawater example, sodium ions (Na⁺) are replaced by H⁺ and the seawater is acidified. The Na⁺ ions move across the cation permeable membrane into the cathode compartment where they recombine with the OH⁻ ions produced at cathode along with H₂ gas from the HER reaction. Each electrode is connected to the DC power source.

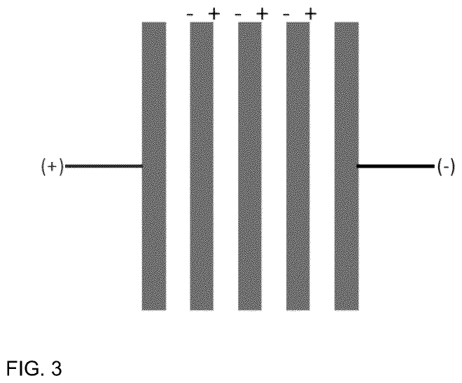

The bipolar configuration example provided in FIG. 3 has four pairs of anodes and cathodes (with membranes and compartment in between) connected in series powered by a single power supply.

In this configuration, the current is supplied through each electrode pair, with the current in each electrode pair being the same. Two different reactions (HER and OER) take place simultaneously on the opposite sides of each electrode not directly connected to the power source. This means that one side of each electrode acts as a cathode and the other as an anode (although both sides are at the same potential), except for the two end electrodes that are connected to the DC power source.

I_{applied}=I_{pair 1}=I_{pair 2}=I_{pair 3}=I_{pair 4}

The voltage drop across power supply will be the total sum of the individual drops across each of the four electrode pairs:

V=V_{pair 1}+V_{pair 2}+V_{pair 3}+V_{pair 4}

Bipolar configuration has lower Ohmic losses in the electrical circuit connectors; however, it demands much higher precision in its design and manufacturing to prevent liquid and gas leakage between compartments.

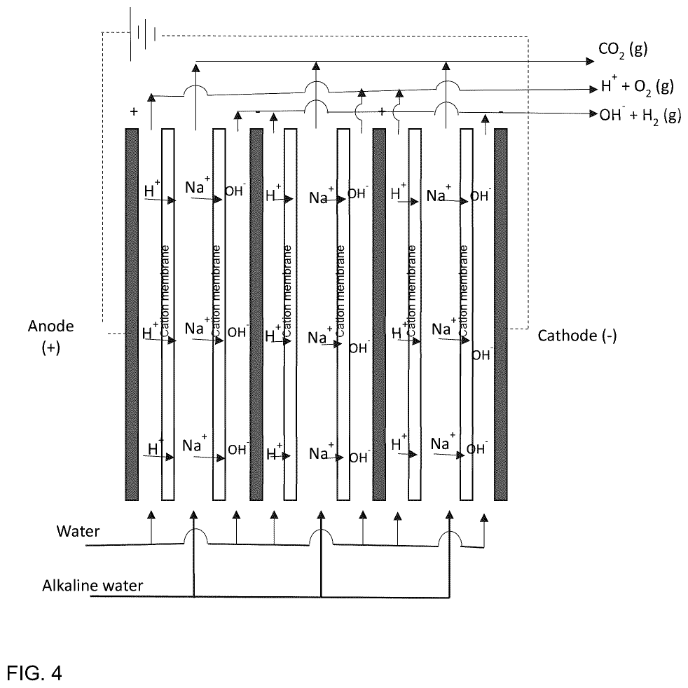

FIG. 4 shows the conceptual design configuration of the module for carbon dioxide removal with a bipolar configuration. The major components of the module include compartments separated by electrode compartments (anode and cathode), and cation-permeable membranes. Hydrogen ions (H⁺) and oxygen gas (O₂) are generated at the electrodes. Current drives the H⁺ ions produced at the anodes through the cation permeable membrane into the compartments containing alkaline water (seawater, freshwater, brine, saturated alkaline carbonate solutions, and brackish water). In the seawater example, sodium ions (Na⁺) are replaced by H⁺ and the seawater is acidified. The Na⁺ ions move across the cation permeable membrane into the cathode compartment where they recombine with the OH⁻ ions produced at cathode along with H₂ gas from the HER reaction. Only the two end electrodes are connected to the DC power source.

The electrochemical module electrodes are identical, titanium plated with platinum, as the polarity of the electrochemical module is reversed during operation based on the process requirements. These requirements include but are not limited to carbon removal, hydrogen generation, and water alkalinity. With the high cost and limited supply of platinum; the use of non-precious metal, metal alloy, or carbon-based (carbon, graphite, etc.) in place of platinum is desirable in splitting water, both as a cathode (HER) and anode (OER).

Module components can be manufactured standard or engineered plastics by a machining or molding process. Modules can be ‘plate-and-frame’, ‘spiral’, or ‘contained in a tubular housing’ design.

Module and system design must incorporate configurations and materials to reduce size, weight, footprint, and cost while maintaining electrical efficiencies to facilitate carbon dioxide and hydrogen gas removal in any water removal application on land or at sea.

Power sources can be electricity from nuclear, green (solar, wind, wave, hydro, geo, etc.), or conventional (coal, natural gas, etc.) depending on the location of the installation.

Parameters that effect the electrical resistance of the electrochemical module and their effects on product versus waste heat and rate of production are:
Voltage: Per unit of energy supplied, in general, a lower voltage produces less waste heat from electrolysis involved in the electrochemical module. Below a certain threshold voltage, no electrolysis will occur.
Concentration: The dilute water flowrate in the electrode compartments have different capacities to conduct and its concentration above or below an ideal will negatively or positively affect its capacity to conduct electricity. The alkaline water source (seawater, freshwater, brine, saturated alkaline carbonate solutions, and brackish water) and its flowrate to the electrochemical module have different capacities to conduct and its concentration above or below an ideal will negatively or positively affect its capacity to conduct electricity.
Temperature: Increasing the temperature of the alkaline water source lowers the resistance of the liquids. Additionally, some of the heat (voltage) used to break up water's molecular bonds will not be required.
Surface Area: Surface area and voltage are proportional. All other parameters being equal, if surface area is doubled (so are the electrodes), resistance will cut in half and so will the voltage.
Spacing: Decreasing the spacing between electrodes decreases resistance (voltage).

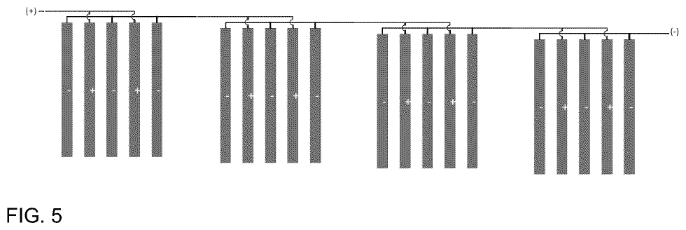

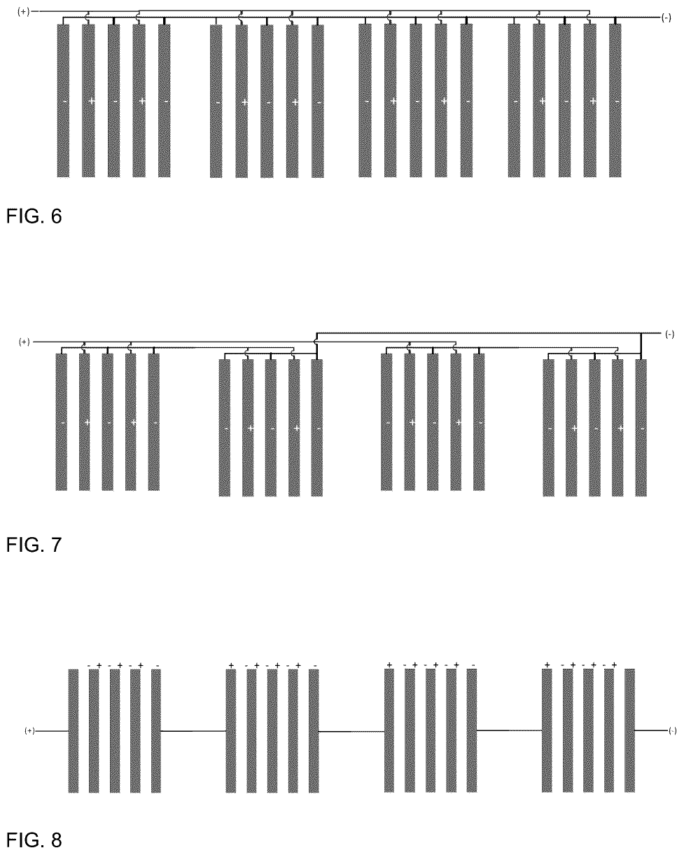

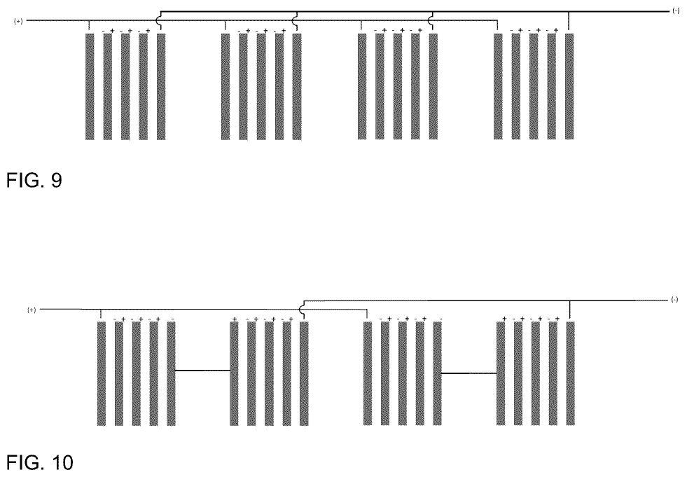

The electrochemical modules can be electrically connected in series, parallel, or combination of both. Examples of these arrangements for unipolar and bipolar modules are shown in shown in FIGS. 5 to 10. FIG. 5 shows four unipolar modules connected in series. FIG. 6 shows four unipolar modules connected in parallel. FIG. 7 shows four unipolar modules connected in series-parallel. FIG. 8 shows four bipolar modules connected in series. FIG. 9 shows four bipolar modules connected in parallel. FIG. 10 shows four bipolar modules connected in series-parallel.

Wiring in the electrochemical modules in series will increase voltage, while wiring in parallel will increase amperage. Both voltage and amperage need to be considered when designing and scaling the process up.

Connecting the electrochemical modules in parallel will increase the amperage and keep the individual module voltage the same. The downside is that high amperage is difficult to travel long distances without using very thick wires and may require copper bus bars and extra equipment such as branch connectors or combiner box.

Connecting electrochemical modules in series will increase the voltage and keep the individual module amperage the same. The benefit of series is that it is easy to transfer over long distances. The downside is if one module in a series circuit fails, then all the modules in the circuit fail because the circuit has been broken. This will not happen in a parallel connection.

The size and number of electrochemical modules used in a system can be limited by the available power source. Control systems are designed to accept a certain amount of amperage and voltage. Often for larger systems, to stay within those parameters of amperage and voltage, series and parallel connection must be considered. There are no downsides to series-parallel connections. They are usually used when needed and other options are not available.

The above descriptions are those of the preferred embodiments of the invention. Various modifications and variations are possible in light of the above teachings without departing from the spirit and broader aspects of the invention. It is therefore to be understood that the claimed invention may be practiced otherwise than as specifically described. Any references to claim elements in the singular, for example, using the articles “a,” “an,” “the,” or “said,” is not to be construed as limiting the element to the singular.

What is claimed as new and desired to be protected by Letters Patent of the United States is:

1. A device for carbon dioxide recovery from alkaline water, comprising
a module comprising at least three compartments, wherein each compartment is separated by an electrode pair comprising an anode and a cathode, wherein each compartment comprises an anode section, an alkaline water section, and a cathode section with cation-permeable membranes separating the anode section from the alkaline water section and the alkaline water section from the cathode section, wherein alkaline water is flowed through the alkaline water section of each compartment, wherein hydrogen ions and oxygen gas are generated at the anode by an oxygen evolution electrochemical reaction and hydroxide ions and hydrogen gas are generated at the cathode by a hydrogen evolution electrochemical reaction, wherein a current drives the hydrogen ions generated at the anode through the cation permeable membrane separating the anode section from the alkaline water section into the alkaline water section, wherein cations in the alkaline water are replaced by hydrogen ions which lowers the pH of the alkaline water, wherein the pH of the alkaline solution is a function of the applied current, wherein the cations move through the cation permeable membrane separating the alkaline water section from the cathode section into the cathode section, wherein the cations combine with the hydroxide ions produced at the cathode, wherein the module produces carbon dioxide, carbonic acid, bicarbonate ions, oxygen gas, hydroxide ions, and hydrogen gas; and
a DC power source connected to at least one electrode pair to provide the current.

2. The device of claim 1, wherein there are no starting electrolytes in the module.

3. The device of claim 1, wherein there is a simultaneous production of hydrogen gas and carbon dioxide at a stoichiometric ratio ranging from 0.5:1 to 5:1.

4. The device of claim 1, wherein the molar ratio of hydrogen gas to carbon dioxide is controlled in part by varying the applied current density.

5. The device of claim 1, wherein the alkaline water can be flowed through each compartment either in a bottom to top direction or in a top to bottom direction.

6. The device of claim 1, wherein the current is capable of reversing the polarity of the anode and the cathode.

7. The device of claim 1, wherein the electrodes are identical to facilitate polarity reversal.

8. The device of claim 1, wherein the electrode pairs have a unipolar configuration wherein the electrode pairs are connected in parallel with one end of each anode connected to a common point and each cathode connected to another common point of the DC power source.

9. The device of claim 1, wherein the electrode pairs have a unipolar configuration, and wherein the current is divided into a separate current for each electrode pair.

10. The device of claim 1, wherein the electrode pairs have a bipolar configuration, and wherein the current is supplied through each electrode pair.

11. The device of claim 1, wherein the electrode pairs have a bipolar configuration wherein the electrode pairs are connected in series with only the two end electrodes being connected to the DC power source.

12. The device of claim 1, wherein the module is connected to at least one additional module in series.

13. The device of claim 1, wherein the module is connected to at least one additional module in parallel.

14. The device of claim 1, wherein the module is connected to at least one additional module in a combination of parallel and series.

15. A process for carbon dioxide recovery from alkaline water, comprising
flowing alkaline water into a module comprising at least three compartments, wherein each compartment is separated by an electrode pair comprising an anode and a cathode, wherein each compartment comprises an anode section, an alkaline water section, and a cathode section with cation-permeable membranes separating the anode section from the alkaline water section and the alkaline water section from the cathode section, wherein the alkaline water is flowed into the alkaline water section of each compartment of the module;
generating hydrogen ions and oxygen gas at the anode by an oxygen evolution electrochemical reaction;
generating hydroxide ions and hydrogen gas at the cathode by a hydrogen evolution electrochemical reaction;
flowing a current through the module, wherein the current drives the hydrogen ions generated at the anode through the cation permeable membrane separating the anode section from the alkaline water section into the alkaline water section, wherein cations in the alkaline water are replaced by hydrogen ions which lowers the pH of the alkaline water, wherein the pH of the alkaline solution is a function of the applied current, wherein the cations move through the cation permeable membrane separating the alkaline water section from the cathode section into the cathode section, wherein the cations combine with the hydroxide ions produced at the cathode, wherein the module produces carbon dioxide, carbonic acid, bicarbonate ions, oxygen gas, hydroxide ions, and hydrogen gas.

16. The process of claim 15, wherein there are no starting electrolytes in the module.

17. The process of claim 15, wherein there is a simultaneous production of hydrogen gas and carbon dioxide at a stoichiometric ratio ranging from 0.5:1 to 5:1.

18. The process of claim 15, wherein the molar ratio of hydrogen gas to carbon dioxide is controlled in part by varying the applied current density.

19. The process of claim 15, wherein the alkaline water can be flowed through each compartment either in a bottom to top direction or in a top to bottom direction.

20. The process of claim 15, wherein the current is capable of reversing the polarity of the anode and the cathode.

21. The process of claim 15, wherein the electrodes are identical to facilitate polarity reversal.

22. The process of claim 15, wherein the electrode pairs have a unipolar configuration wherein the electrode pairs are connected in parallel with one end of each anode connected to a common point and each cathode connected to another common point of the DC power source.

23. The process of claim 15, wherein the electrode pairs have a unipolar configuration, and wherein the current is divided into a separate current for each electrode pair.

24. The process of claim 15, wherein the electrode pairs have a bipolar configuration, and wherein the current is supplied through each electrode pair.

25. The process of claim 15, wherein the electrode pairs have a bipolar configuration wherein the electrode pairs are connected in series with only the two end electrodes being connected to the DC power source.

26. The process of claim 15, wherein the module is connected to at least one additional module in series.

27. The process of claim 15, wherein the module is connected to at least one additional module in parallel.

28. The process of claim 15, wherein the module is connected to at least one additional module in a combination of parallel and series.
